(19) United States
(12) Patent Application Publication
(10) Pub. No.: US 2013/0254028 A1
(43) Pub. Date: Sep. 26, 2013

(54) SYSTEM AND METHOD FOR CONDUCTING MOBILE COMMERCE

(71) Applicant: CORBUSS KURUMSAL TELEKOM HIZMETLERI A.S., Istanbul (TR)

(72) Inventor: Ali Salci, Istanbul (TR)

(73) Assignee: CORBUSS KURUMSAL TELEKOM HIZMETLERI A.S., Istanbul (TR)

(21) Appl. No.: 13/748,010

(22) Filed: Jan. 23, 2013

Related U.S. Application Data
(60) Provisional application No. 61/614,170, filed on Mar. 22, 2012.

(51) Int. Cl. G06Q 20/32

(52) U.S. Cl. CPC G06Q 20/322
USPC 705/14.53; 705/14.64

(57) ABSTRACT

In a system for conducting mobile commerce, a mobile operator central server sends silent authorization messages to a smartphone including a wallet application responsive to received messages to display offers, advertisements or coupons to a user. A wallet manager application resident on a remote server for selecting offers, advertisements or coupons relevant to a particular user from multiple data sources sends the selected offers or coupons in messages over a wireless link to the wallet application. The mobile operator central server receives information from the user in response to the wallet application presenting a buy option to the user. The mobile operator central server sends an authorization message to a secure payment application resident on the smartphone to present the user with a payment interface.

### CROSS REFERENCE TO RELATED APPLICATION

This invention claims the benefit under 35 USC 119(e) of U.S. provisional application No. 61/614,170, filed Mar. 22, 2012.

### FIELD OF THE INVENTION

The present invention relates to the field of mobile phone technology, and in particular to a method and system for conducting mobile commerce through a smartphone.

### BACKGROUND OF THE INVENTION

Mobile commerce refers to searches and purchases enabled by a mobile phone or device. Mobile devices link the offline world with the online, enabling merchants to develop new methods of targeted, real-time and location-based marketing, focused CRM and preauthorized sales. Social media is involved, with peer-based recommendations and interactive consumer experiences. New business models and revenue pools are emerging along the retail value chain, and payments organizations are leveraging mobile marketing to achieve a compelling value proposition for consumers and merchants. This is a new area of communication and social networking where
customers can evaluate products and merchants and share promotional offers and coupons with friends
customers can pay for products, coupons or offers using various forms of payment options from their phone

There are a number of services currently available. For example, Cellfire lets the user sign up for specific deals and receive coupons based on triggers, for example, location. Groupon alerts smart phone users to nearby business deals. Foursquare lets the user keep up with friends, discover what's nearby and save money and unlock rewards based on location.

American Express recently partnered with foursquare and Facebook to provide consumers with targeted offers based on social recommendations and location information.

Currently, however, smartphone users receiving offers or coupons are typically required to present their smartphone to a point of sale to pay for a particular offer or service. For example, Google Wallet is a mobile payment system that allows users to make point-of-sale payments via their smartphones, using a variety of payment methods. Google Wallet can store information about a user's debit or credit cards, gift cards, loyalty cards, and even digital coupons or promotional offers. Payments are made by tapping a smartphone against a compatible reader, or just waving the phone very close to the reader, which uses NFC (Near Field Communications) to transfer data from the phone. Google Wallet stores the encrypted payment card credentials on a computer chip on the phone called the Secure Element. The Secure Element is a separate chip, capable of running programs and storing data. The Secure Element is separate from the phone's memory. The chip is designed to only allow trusted programs on the Secure Element itself to access the payment credentials stored therein. It is not generally available to user applications running on the smartphone.

There are also other problems with current systems:
1. Capturing and aggregating data related to advertisements, coupons, and deals.
2. Ads can appear on phones as (potentially annoying) pop-ups or can be listed less obtrusively in folders which users must open in order to browse ads.
3. Depending on user location, a phone can become inundated with ads from different merchants or even from one single merchant. App providers and partner merchants face the threat of user rejection and negative user feedback if users are overwhelmed with ads. Users may be excited to receive a coupon for a new merchant or from their favorite merchant, but users can be turned off by too many ads from one merchant or by ads that don't auto-delete after a certain timeframe.
4. Irrelevant ads or coupons. Non-coffee drinkers don't want to receive ads for local coffee shops.
5. A key challenge for merchants is ensuring presence on appropriate apps. Some app providers automatically include listings of local merchants, while others go through the laborious task of “signing up” one merchant partner at a time.
6. Only an approved wallet application can access secured credentials directly. There is no way to allow third-party applications to access these credentials from outside the designated wallet. For example, imagine a consumer using a merchant provided application to check in-store offers by using the GPS capabilities or GSM location-based services on their devices. The same consumer may then have to open up the separate wallet application to use their credit card (or the merchant-provided coupon) at the retail POS for checkout since that is the only approved application to access the secure credentials stored on the mobile phone.
7. There are various legal, operational and technical issues for storing and sharing of sensitive financial data on the mobile phones.

### SUMMARY OF THE INVENTION

According to the present invention there is provided a system for conducting mobile commerce, comprising: a mobile operator central server configured to send silent authorization messages to a smartphone including a wallet application responsive to received messages to display offers, advertisements or coupons to a user; a wallet manager application resident on a remote server for selecting offers, advertisements or coupons relevant to a particular user from multiple data sources and sending the selected offers or coupons in messages over a wireless link to the wallet application on the smartphone; the mobile operator central server being configured to receive merchant, user and price information from the user in response to the wallet application presenting a buy option to the user for a selected offer, advertisement or coupon and a buy action being initiated by the user; and the mobile operator central server being operable to send an authorization message to a secure payment application resident on the smartphone to present the user with a payment interface enabling the user to confirm payment for the selected offer or to use the coupon for a purchase.

While the payment application is normally associated with a SIM card and not directly accessible to the user, embodiments of the invention overcomes this problem by arranging for authorization messages to be sent from the mobile operator. The messages are preferably sent in a GSM system using silent Short Message Service (SMS) messages. SMS is a text messaging service component of phone, web, or mobile communication systems, using standardized communications protocols that allow the exchange of short text messages between mobile phone devices. It is a popular data service offered by mobile network operators and most widely used for mobile payments. It is relatively cheap and easy to use. The SMS capabilities can be used for basic functionalities like bank account enquiries or SMS based payments or ticketing. By offering SMS-based mobile payment services most users can be reached as SMS is the most accepted technology in mobile phones. Silent messages, often called “silent sms, “stealth sms,” or “stealthy ping,” are a type of SMS message that will not show up on the display and there is no acoustical signal when they are received.

Embodiments of the present invention offers customers ads, coupons and offers within the wallet application, and lets them pay for them within the application as well. Also there is no need to sort through myriads of offers. The application takes into account many different factors, and only shows ones that are relevant:
valid right now, or within a timeframe that is acceptable to each individual user
available near them
targeted to their tastes and buying patterns

It can also shows the user via social networking access, the friends that have used them. It is also flexible enough to be able to add in more merchants without having to make any modifications to the application. It can also easily change parameters on how to choose relevance for a particular customer or group of customers. It uses a method utilizing silent SMS to get around the accessing of secured credentials within the wallet application.

In another aspect the invention provides a method of conducting mobile commerce with a smartphone user, comprising selecting offers, advertisements or coupons relevant to a particular smartphone user in a wallet manager application resident on a remote server from multiple data sources; and sending the selected offers, advertisements or coupons in messages over a wireless link to a wallet application on the smartphone; the wallet application displaying the selected offers, advertisements or coupons to the smartphone user; the wallet application accepting buy requests from the smartphone user and in response to a buy request sending merchant, user and price information to a mobile operator central server; and the mobile operator sending an authorization message to a secure payment application resident on the smartphone in response to a buy request received at the mobile operator central server enabling the user to complete payment for the selected offer, or apply a coupon to a purchase via the secure payment application.

The invention further comprises a smartphone a smartphone comprising a wallet application responsive to received messages to display offers, advertisements or coupons to a user; the wallet application being configured to present a buy option to the user for a selected offer, advertisement or coupon and in response to a buy action by the user, sending merchant, user and price information to a mobile operator central server; and a secure payment application resident on the smartphone accessible by the user in response to an authorization message received from the mobile operator central server to present the user with a payment interface enabling the user to confirm payment for the selected offer or to use the coupon for a purchase.

### BRIEF DESCRIPTION OF THE DRAWINGS

The invention will now be described in more detail, by way of example only, with reference to the accompanying drawings, in which:

FIG. 1 shows the overall layout of as system in accordance with an embodiment of the invention;

FIG. 2 shows a possible home screen for the Smartphone Wallet App 107;

FIG. 3 shows exemplary smartphone screens where the Payment app is used to pay for the coupon/offer;

FIG. 4 shows exemplary internal steps carried out on the Smartphone 100 (Terminal on diagram) and message flow;

FIG. 5 shows a breakdown of the components and where they fit in the network; and

FIG. 6 is a more detailed breakdown of the components of FIG. 1.

### DETAILED DESCRIPTION OF EMBODIMENTS OF THE INVENTION

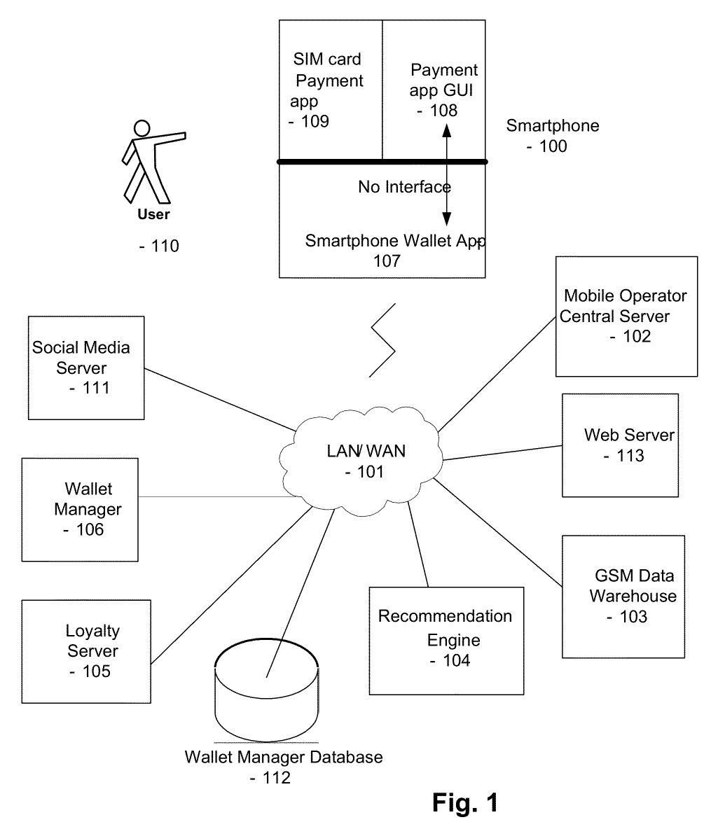

As shown in FIG. 1, a Smartphone 100, such as an Apple Iphone™ or the like is connected to the LAN/WAN 101 via standard means using a wireless connection. A Mobile Operator Central Server 102 connected to the LAN/WAN 101 is used to communicate with the Smartphone Wallet App 107 and Payment App 109.

The GSM Data Warehouse 103 connected to the LAN/WAN 101 contains all the GSM data about the smartphone User 110, including: Age, Sex, Profession, Segment, Location, Cell Usage by City, Travel Frequency, previous use of Mobile Operator Central Campaign's, Traits (Young, Professional, Housewife, etc.), Interests (Automotive, Football Team, Technology, Culture & Art, Fashion, Food, etc.).

The Recommendation Engine 104, connected to the LAN/WAN 101 receives Historical offer data (including what the User 110 chose) from the Wallet Manager 106, GSM data from the GSM Data Warehouse 103 (including location), and ads/offers/coupons from the Loyalty Server 105. It is responsible for combining all this information together to come up with the best ads/offers/coupons to give to the User 110.

The Loyalty Server 105, connected to the LAN/WAN 101 holds all the possible ads/offers/coupons available and uses the Social Media Server 111 to find out the friends of the User 110 who have bought them. It also knows how many there are, and how many are left. The Wallet Manager 106, connected to the LAN/WAN 101 interfaces with the Smartphone Wallet App 107 on the smartphone 100 through the Web Server 113. The Web Server 113 is a standard web server which functions as the secure access point for messages from outside the network.

The Wallet Manager 106 is the portal for the Smartphone Wallet App 107, and for each User 110, it stores historical information about what ads/offers/coupons they have received in the past, as well as which ones they used. It is also responsible for pushing ads/offers/coupons to the User 110 via the Smartphone Wallet App 107. On the smartphone SIM card, resides the Payment App 109 and the Payment App GUI 108 is the only means of accessing it for making payments. The payment application is associated with the SIM card and not normally accessible to user applications on the smartphone.

In an exemplary embodiment the following steps occur:
1. The Smartphone Wallet App 107 on Smartphone 100 makes a request of Wallet

Manager 106 to retrieve the latest ads/offers/coupons. This is either triggered by a timer in the Smartphone Wallet App 107 on a periodic basis, or by the User 110.
2. The Wallet Manager 106 asks the Recommendation Engine 104 to retrieve a list of ads/offers/coupons, passing it historical data for the User 110.
3. The Recommendation Engine 104 asks the Loyalty Server 105 for a current list of Ads/offers/coupons.
4. The Recommendation Engine 104 asks for data on User 110 from the GSM Data Warehouse 103.
5. Using all the data, the Recommendation Engine 104 determines a prioritized list and picks the top x ads/offers/coupons and sends them to the Wallet Manager 106, where x is a configurable number.
6. The Wallet Manager 106 pushes the ads/offers/coupons to the Smartphone Wallet App 107, which displays the list to the User 110 on the Smartphone 100.
7. When a User 110 looks at a coupon, the Smartphone Wallet App 107 sends a request to the Wallet Manager 106 to get a list of people that used the same coupon.
8. The Wallet Manager 106 sends the request along with the Offer ID to the Loyalty Server 105 in order to get the data of the people who used the coupon before.
9. The Loyalty Server 105 produces the list of people who used this coupon.
10. Then the Loyalty Server 105 sends the data to the Social Media Server 111 to find the subscriber's friends who used this coupon before.
11. Social Media Server 111 finds the people.
12. Friends of the subscriber are sent by the Social Media Server 111 through the Loyalty Server 105 to the Wallet Manager 106 to the Smartphone Wallet App 107.
13. The User 110 uses the Smartphone Wallet App 107 to select an offer/coupon and chooses to ‘buy’ it. If not, they return to Step 4.
14. The merchant, the amount and the user phone number is sent to the Mobile Operator Central Server 102.
15. The Mobile Operator Central Server 102 uses a “Silent SMS” to send a message to the User's 110 Smartphone 100, which then has access to the SIM card Payment app 109, which the user can then use to pay for the offer. One exemplary way of achieving this is described in the PCT application PCT/IB2012/050450 titled A MOBILE FINANCIAL TRANSACTION SYSTEM AND METHOD, which is herein incorporated by reference. Basically the payment application in the smartphone opens a secure channel to a payment center, which then processes the payment. As a result, in this embodiment, it is not necessary to store the PIN number on the smartphone. However, in an alternative embodiment, the PIN number can be stored on the SIM card, and verified against the number entered by the user.

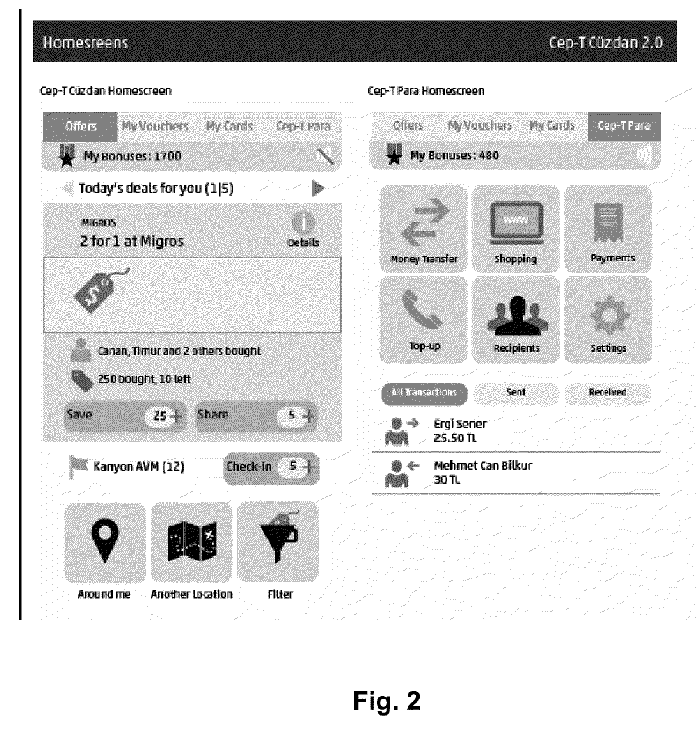

The home screen for the Smartphone Wallet App 107 illustrated in FIG. 2 shows the offers available to the User 110. The screen presents the user with choices and also permits him to vary the selection parameters, for example, to filter offers or to select offers relevant to location.

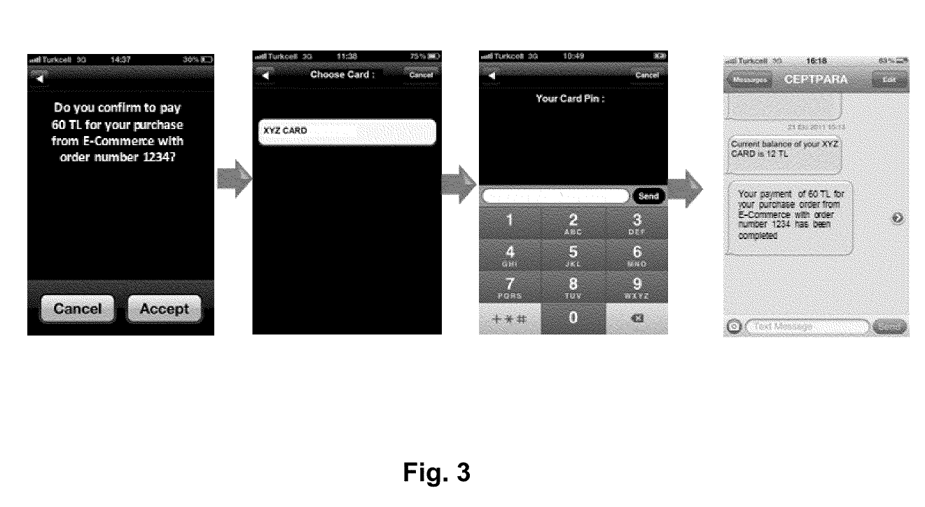

FIG. 3 shows possible smartphone screens for Step 13, where the Payment app 109 is used to pay for the coupon/offer. This process is described in detail in the PCT application PCT/IB2012/050450 titled A MOBILE FINANCIAL TRANSACTION SYSTEM AND METHOD. The system takes advantage of the payment application associated with the SIM card, which is available to the mobile operator. Upon accepting a particular offer, the user is then presented with a screen allowing him to pay for it on the spot without the need to go to a POS terminal. The payment is made through the mobile operator who in turn can reimburse the merchant.

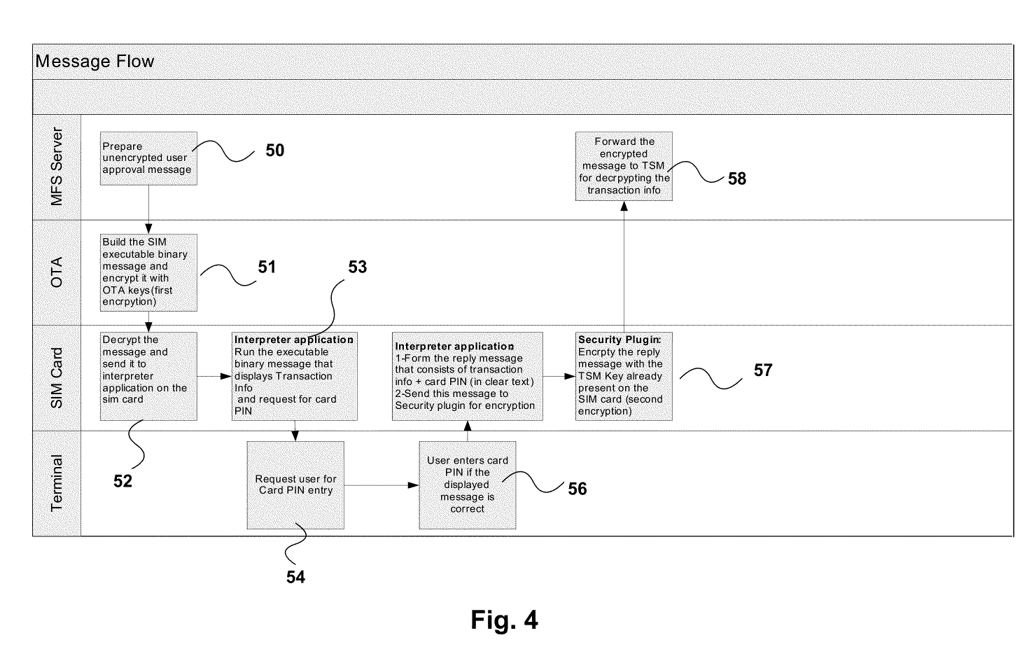

FIG. 4 shows the internal steps carried out on the Smartphone 100 (Terminal on diagram) and message flow for Step 13 (MFS Server is Mobile Operator Central Server 102). OTA is Over the Air. SIM Card is the SIM card payment app 109 and Payment app GUI 108.

First, at step 50 the MFS server prepares an unencrypted use approval message, which is then built into a SIM executable binary message at step 51 for transmission over the air to the SIM card, where at step 52 the message is decrypted.

The SIM card runs the executable binary message that displays the transaction information and request the PIN from the user at step 53. At step 54, the PIN request is displayed to the user, who enters the PIN and step 56, whereupon it is sent to the SIM card, which at step 55 forms the reply message, which is encrypted at step 57 and sent back over the air to the transaction server (TSM) for decryption.

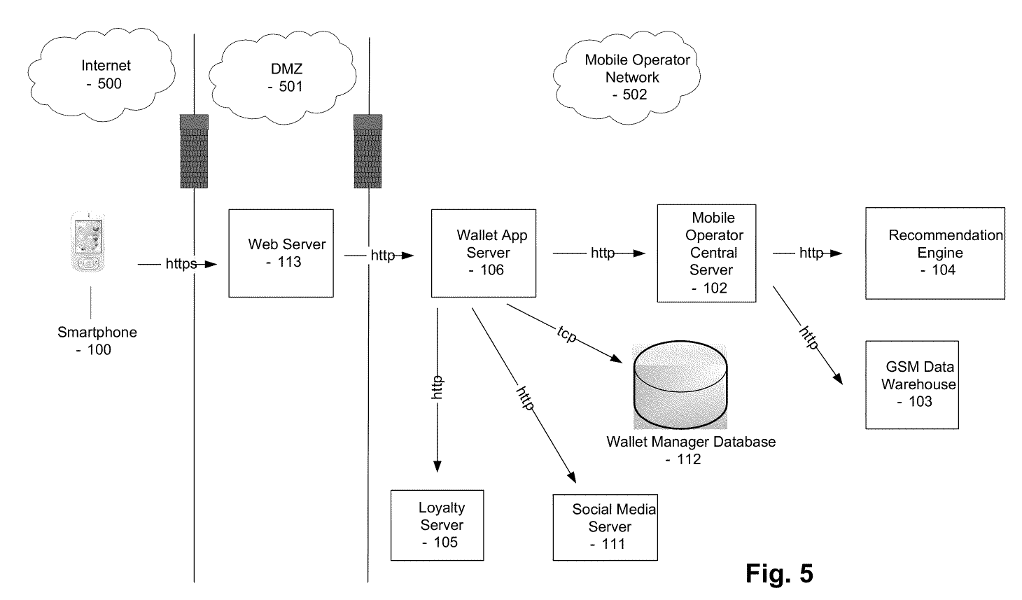

FIG. 5 shows a breakdown of the components and where they fit in the network, either out in the Internet 500, in the intervening zone (DMZ) 501, or in the Mobile Operator Network 502.

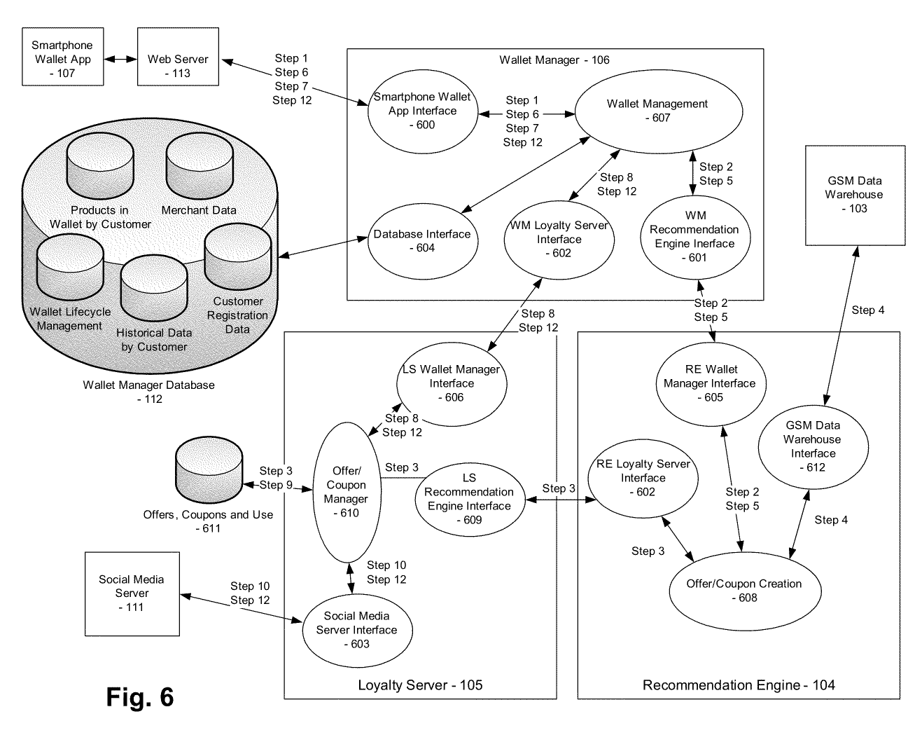

FIG. 6 is a more detailed breakdown of the components of FIG. 1, also referencing the Steps and where they fit in the flow of messages between components. Inside the Wallet Manager 106, there is Smartphone Wallet App Interface software 600, which uses an API to talk to the Smartphone Wallet App 107.

The Wallet Management software 607 is responsible for coordinating all the requests and receipts of data for the process. It also uses the Database Interface 604 to retrieve any wallet data from the Wallet Manager Database 112. This database includes the products in the wallet for each customer, merchant data, customer registration data and wallet lifecycle management. This is also where the historical data resides.

The WM Loyalty Server Interface 602 uses an API to interact with the Loyalty Server 105. The WM Recommendation Interface 601 uses an API to interact with the Recommendation Engine 104. Inside the Recommendation Engine 104 is the RE Wallet Manager Interface software 605 which uses an API to interface with the Wallet Manager 106.

The Offer/Coupon Creation software 608 receives requests to create lists and retrieve data on coupons and offers. It uses the GSM Data Warehouse Interface 612 to retrieve location data and GSM user data on User 110. The GSM Data Warehouse Interface 612 uses an API to talk to the GSM Data Warehouse 103 to retrieve the necessary data. The RE Loyalty Server Interface software 602 uses an API to interface with the Loyalty Server 105 to retrieve current ads/offers/coupons.

The Loyalty Server 105 has LS Recommendation Engine Interface software 609 which uses an API to interface with the Recommendation Engine 104. The Loyalty Server 105 has LS Wallet Manager Interface software 606 which uses an API to interface with the Wallet Manager 106. When a request is made for information, it is passed to the Offer/Coupon Manager 610, which is responsible for collecting the data from the Offers, Coupons and Use Database 611. To find the correct friends information on a particular coupon/offer, the Offer/Coupon Manager 610 uses the Social Media Server Interface software 603, which uses an API to retrieve data from the Social Media Server 111.

It should be appreciated by those skilled in the art that any block diagrams herein represent conceptual views of illustrative circuitry embodying the principles of the invention. For example, a processor may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. The functional blocks illustrated herein may in practice be implemented in hardware or software.

1. A system for conducting mobile commerce, comprising:
a mobile operator central server configured to send silent authorization messages to a smartphone including a wallet application responsive to received messages to display offers, advertisements or coupons to a user;
a wallet manager application resident on a remote server for selecting offers, advertisements or coupons relevant to a particular user from multiple data sources and sending the selected offers or coupons in messages over a wireless link to the wallet application on the smartphone;
the mobile operator central server being configured to receive merchant, user and price information from the user in response to the wallet application presenting a buy option to the user for a selected offer, advertisement or coupon and a buy action being initiated by the user; and
the mobile operator central server being operable to send an authorization message to a secure payment application resident on the smartphone to present the user with a payment interface enabling the user to confirm payment for the selected offer or to use the coupon for a purchase.

2. A system as claimed in claim 1, wherein the authorization messages are sent as silent SMS messages.

3. A system as claimed in claim 1, wherein the wallet manager is configured to request offers, advertisements or coupons from the wallet manager on a periodic basis or in response to a user request.

4. A system as claimed in claim 1, wherein the wallet manager application obtains offers, advertisements or coupons from a recommendation engine that retrieves data at least from a loyalty server and a data warehouse storing data about the user to select relevant offers, advertisements or coupons for presentation to the user.

5. A system as claimed in claim 4, wherein the wallet manager further obtains information from a social media server to identify friends of the user who have accepted a particular offer or coupon, the wallet manager being configured to send the friend information to the smartphone for display to the user.

6. A system as claimed in claim 1, wherein the secure payment application resident on the smartphone is associated with a SIM card requiring authorization from the mobile operator.

7. A system as claimed in claim 1, further comprising a wallet manager database storing product information currently in a user's wallet application.

8. A system as claimed in claim 1, which is a distributed system with multiple servers interconnected over a network.

9. A system as claimed in claim 1, wherein the payment application is configured to invite the user to enter a PIN number to complete a purchase, and the payment application verifies the entered PIN number against data securely stored on the phone, and wherein the secure payment application opens a secure channel to a payment center for processing the payment.

10. A system as claimed in claim 1, wherein the wallet application is configured to filter the offers, advertisements or coupons in response to user input.

11. A method of conducting mobile commerce with a smartphone user, comprising:
selecting offers, advertisements or coupons relevant to a particular smartphone user in a wallet manager application resident on a remote server from multiple data sources;
and sending the selected offers, advertisements or coupons in messages over a wireless link to a wallet application on the smartphone;
the wallet application displaying the selected offers, advertisements or coupons to the smartphone user;
the wallet application accepting buy requests from the smartphone user and in response to a buy request sending merchant, user and price information to a mobile operator central server; and
the mobile operator sending an authorization message to a secure payment application resident on the smartphone in response to a buy request received at the mobile operator central server enabling the user to complete payment for the selected offer, or apply a coupon to a purchase via the secure payment application.

12. A method as claimed in claim 11, wherein the authorization messages are sent as silent SMS messages.

13. A method as claimed in claim 11, wherein the wallet application requests offers, advertisements or coupons from the wallet manager on a periodic basis or in response to a user request.

14. A method as claimed in claim 11, wherein the wallet manager obtains offers, advertisements or coupons from a recommendation engine that retrieves data at least from a loyalty server and a data warehouse storing data about the user to select relevant offers, advertisements or coupons for presentation to the user.

15. A method as claimed in claim 14, wherein the wallet manager further obtains information from a social media server to identify friends of the user who have accepted a particular offer or coupon, and sends the friend information to the smartphone for display to the user.

16. A method as claimed in claim 11, wherein the secure payment application resident on the smartphone is associated with a SIM card requiring authorization from the mobile operator.

17. A method as claimed in claim 11, further comprising storing product information currently in a user's wallet application in a central warehouse database.

18. A method as claimed in claim 11, wherein the payment application invites the user to enter a PIN number to complete a purchase, and the payment application verifies the entered PIN number against data secure securely on the phone, and wherein the secure payment application opens a secure channel to a payment center, which processes the payment.

19. A distributed central system for conducting mobile commerce with a remote smartphone, comprising:
a mobile operator central server capable of sending silent authorization messages to the remote smartphone; and
a wallet manager application resident on a remote server for selecting offers, advertisements or coupons relevant to a particular user from multiple data sources and sending the selected offers, advertisements or coupons in messages over a wireless link to a wallet application resident on the remote smartphone; and
wherein the mobile operator central server is responsive to messages received from the smartphone to send the silent authorization messages to a secure payment application resident on the smartphone to present the user with a payment interface enabling the user to complete payment for the selected offer or to use the coupon for a purchase.

20. A system as claimed in claim 19, wherein the authorization messages are sent as silent SMS messages.

21. A system as claimed in claims 19, wherein the wallet manager application obtains offers, advertisements or coupons from a recommendation engine that retrieves data at least from a loyalty server and a data warehouse storing data about the user to select relevant offers for presentation to the user.

22. A system as claimed in claim 19, wherein the wallet manager further obtains information from a social media server to identify friends of the user who have accepted a particular offer or coupon, the wallet manager application being configured to send the friend information to the smartphone for display to the user.

23. A system as claimed in claim 19, further comprising a wallet manager database storing product information currently in a user's wallet application.

24. A smartphone comprising:
a wallet application responsive to received messages to display offers, advertisements or coupons to a user;
the wallet application being configured to present a buy option to the user for a selected offer, advertisement or coupon and in response to a buy action by the user, sending merchant, user and price information to a mobile operator central server; and
a secure payment application resident on the smartphone accessible by the user in response to an authorization message received from the mobile operator central server to present the user with a payment interface enabling the user to confirm payment for the selected offer or to use the coupon for a purchase.
